(19) United States
(12) Patent Application Publication
(10) Pub. No.: US 2003/0046309 A1
(43) Pub. Date: Mar. 6, 2003

(54) Method and apparatus for aggregating and maintaining variable data across platforms

(76) Inventors: Richard McGrath, Sandy Hook, CT (US); Clint Donley, Norwalk, CT (US); Scott Lubliner, Wilton, CT (US); Mahim Sharma, Stamford, CT (US); Muthukumar Kumaresan, Stamford, CT (US); Ramana S. Kumar Sakamuri, Stamford, CT (US)

Correspondence Address: BUCKLEY, MASCHOFF, TALWALKAR, & ALLISON, 5 ELM STREET, NEW CANAAN, CT, 06840, US

(21) Appl. No.: 09/880,694

(22) Filed: Jun. 13, 2001

(51) Int. Cl. G06F 12/00

(52) U.S. Cl. 707/200

(57) ABSTRACT

A system, method, apparatus, and computer program code for aggregating and maintaining data in a system having at least a first and a second platform generating data includes receiving initial data from the first and the second platforms. A staging table is generated based on the initial data, and the standardized data is associated with the initial data. In one embodiment, the association is performed by establishing one or more cross-reference tables.

### FIELD OF THE INVENTION

The present invention relates to data processing systems. More particularly, embodiments of the present invention relate to the maintenance of data shared between different platforms, systems, or applications.

### BACKGROUND OF THE INVENTION

Advances in computer systems and application software have greatly simplified many aspects of doing business. Large companies typically utilize a number of different off-the-shelf or customized application programs to automate various tasks. For example, a financial services company may use one software package to automate loan approvals, another software package to monitor and track loan paperwork, and another software package to maintain historical customer information. Frequently, each of the different packages may utilize different data naming and formatting conventions. As a result, data from one application may not be usable in the other applications.

It would be desirable to provide a method by which an entity could ensure that data used by one of the applications is consistent with data used in the other applications. One way to achieve such consistency is to develop a single application that integrates the functionality of the various packages, however, this can be expensive and disruptive to existing operations. It would be desirable to provide data consistency without the need to undertake large scale system integration activities.

### SUMMARY OF THE INVENTION

Embodiments of the present invention provide a system, method, apparatus, and computer program code for aggregating and maintaining variable data across platforms.

According to one embodiment of the present invention, a method of aggregating and maintaining data in a system having at least a first and a second platform generating data includes receiving initial data from the first and the second platforms. A staging table is generated based on the initial data, and the standardized data is associated with the initial data. In one embodiment, the association is performed by establishing one or more cross-reference tables.

According to one embodiment of the present invention, updated data from the first and second platforms is periodically received and compared with data in the staging table to determine if the updated data includes new data. If the updated data includes new data, according to one embodiment of the invention, a flag is set in the staging table and the updated data is compared with the standardized data to determine if the standardized data should be updated to reflect the updated data. In one embodiment, the comparison involves a visual comparison of data. In other embodiments, the comparison involves an automated comparison of data.

According to one embodiment of the present invention, the received updated data is analyzed to determine if it includes modified data. If it includes modified data, a determination is made whether to modify the standardized data or to reject the updated data and keep the standardized data unchanged.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system consistent with the present invention;

FIG. 2 is a flow diagram illustrating an exemplary system initialization process according to one embodiment of the present invention;

FIG. 3 is a flow diagram illustrating an exemplary data update process according to one embodiment of the present invention;

FIGS. 4A and 4B are tabular representations of portions of existing system databases according to an embodiment of the present invention; and

FIGS. 5A and 5B are tabular representations of portions of cross-reference databases according to embodiments of the present invention.

### DETAILED DESCRIPTION

Applicants have recognized that there is a need for a system, method, apparatus, and computer program code for aggregating and maintaining variable data across platforms that overcomes drawbacks of existing systems.

For clarity and consistency, a number of terms are used herein. As used herein, the term “platform” or “existing platform” refers to application software or software packages that are operated by or on behalf of an entity that generate, use, or manipulate data. Embodiments of the present invention permit the aggregation and maintenance of data generated, used, or manipulated by different platforms.

Features and advantages of embodiments of the present invention will be discussed detail below, by first describing the system and devices of the system. Throughout this disclosure, an example system will be used to describe and illustrate features of embodiments of the present invention. The example system involves several platforms which generate and use customer data of various types. An exemplary embodiment of a system utilizing features of the present invention will be described (along with exemplary databases used therein). Finally, processes according to embodiments of the invention will be described.

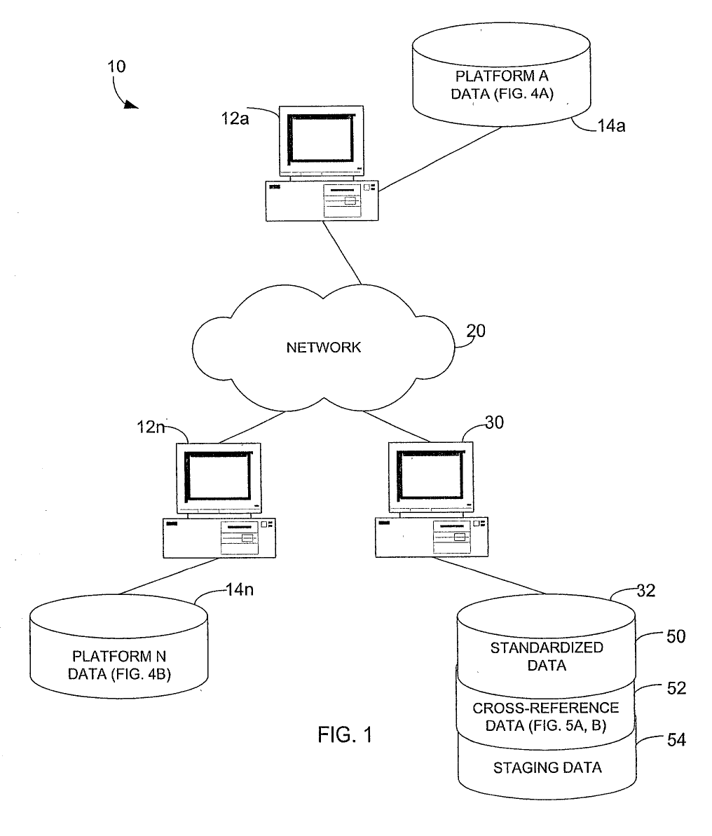

Referring first to FIG. 1, a system 10 according to one embodiment of the present invention is shown. System 10, as depicted, includes a number of platforms 12a-n in communication with an aggregator 30 via a network 20. Each of the platforms 12a-n and the aggregator 30 are in communication with data storage devices 14a-n and 32, respectively. Each of the platforms 12a-n and the aggregator 30 may include one or more general purpose computers operating application software. In one embodiment of the present invention, each of the platforms 12a-n generates, stores, and utilizes customer data. Data generated, stored, and utilized at platforms 12a-n may include data that is not standardized (e.g., data naming and storage conventions may be different between the different platforms).

In one embodiment, aggregator 30 also generates, stores, and utilizes customer data. According to embodiments of the present invention, aggregator 30 is operated to aggregate and maintain data from each of the platforms 12a-n. The result is a system that allows the efficient integration and standardization of data from different systems.

In one embodiment, platforms 12a-n and aggregator 30 are operated by the same entity. In other embodiments, one or more of the devices may be operated by different partys in communication via network 20. In one embodiment, platforms 12a-n and aggregator 30 are general purpose computers (e.g., including one or Intel® Pentium® processors, or the like).

Those skilled in the art will recognize, upon reading this disclosure, that any or all of platforms 12a-n and aggregator 30 may be implemented as a system controller, a dedicated hardware circuit, an appropriately programmed general purpose computer, or any other equivalent electronic, mechanical or electromechanical device capable of providing the functionality described herein.

In one embodiment, platforms 12a-n and aggregator 30 are in communication with each other via network 20. Network 20 may any of a number of networks, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology. Platforms 12a-n and aggregator 30 may include one or more communication devices (not shown) that facilitate communication via network 20. Any of a number of known communication devices may be used, including, for example, modems, network cards, etc. Platforms 12a-n and aggregator 30 need not be in constant communication with each other, rather, platforms 12a-n need only communicate periodically with aggregator 30 transfer and exchange data as described herein.

Platforms 12a-n and aggregator 30 are each in communication with one or more data storage devices 14a-n and 32, respectively. Data storage devices 14a-n and 32 comprise an appropriate combination of magnetic, optical and/or semiconductor memory, and may include, for example, Random Access Memory (RAM), Read-Only Memory (ROM), a compact disc and/or a hard disk.

Platforms 12a-n and aggregator 30 each store one or more application programs that generate and use data stored in data storage devices 14a-n and 32. Platforms 12a-n and/or aggregator 30 may also store programs causing the devices to operate in accordance with the present invention, and particularly in accordance with the methods described in detail herein. Embodiments of the present invention are not limited to any specific combination of hardware and software.

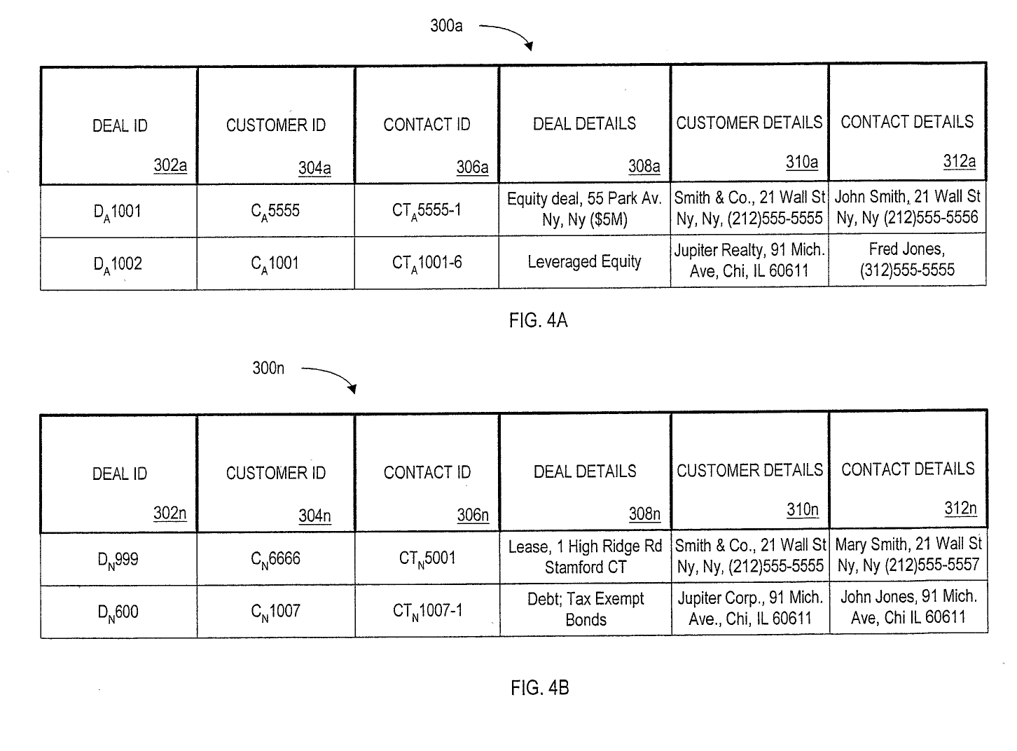

Data storage devices 14a-n store data used by platforms 12a-n. As one illustrative example, data storage devices 14a-n store customer data used by application programs operated at platforms 12a-n. In one embodiment, the data stored at platform 12a may be formatted differently than the data stored at platform 12n. Exemplary data stored at platform 12a will be described below by reference to FIG. 4A. As will be described, embodiments of the present invention allow such different data formats to be aggregated and maintained by one system without the need for expensive system integration or retrofit.

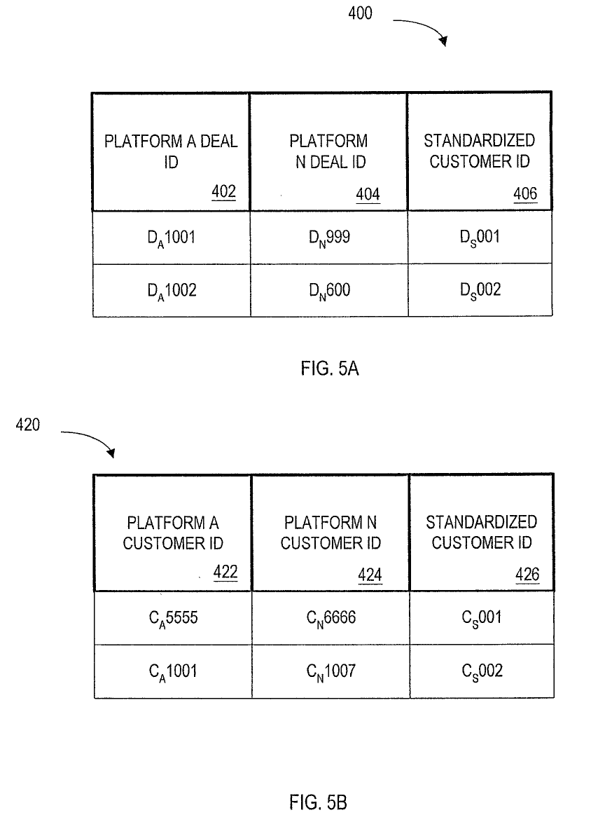

Data storage device 32, in communication with aggregator 30, is used in one embodiment of the present invention to store data including standardized data 50, cross-reference data 52, and staging data 54. Exemplary cross-reference data which may be stored at device 32 will be described below by reference to FIGS. 5A, B. Prior to a discussion of the exemplary databases, an example system incorporating features of the present invention will now be described.

Applicants have found that features of embodiments of the present invention may be used with beneficial results at a financial services company which operates multiple application programs intended to track, monitor, generate, and update information regarding real estate transactions. In particular, embodiments of the present invention have been designed to aggregate and maintain variable customer and deal data across several different platforms used at a financial services company, where each of the platforms are unable to process or utilize data from the other. In the exemplary embodiment, one platform (e.g., represented by platform 12a of FIG. 1) generates real estate deal data, along with customer information for each of the deals. A second platform (e.g., represented by platform 12n of FIG. 1) generates customer and contact information. Neither platform 12a nor platform 12n may read, utilize or otherwise process data from the other.

Pursuant to embodiments of the present invention, an aggregator 30 is provided which allows the aggregation and maintenance of data from both platforms 12a and 12n. According to embodiments of the invention, a process for identifying and entering new customer information from platforms 12a-n is provided, and a process for identifying and updating changed customer information received from platforms 12a-n is provided. Operation of the system pursuant to embodiments of the invention permits the aggregation and maintenance of large amounts of data between different platforms. The result is a system which ensures that current and useful data is shared among different platforms without the need to perform expensive and inefficient manual comparisons of data and without the need to retrofit or replace existing systems. In the example real estate embodiment, features of the present invention permit the financial institution to capture and leverage customer data from different platforms, providing management and marketing staffs with current and accurate customer data from different platforms, allowing the institution to take advantage of new customer service and marketing opportunities.

Example data used in the exemplary system will now be described by referring to FIGS. 4-5. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

Referring first to FIGS. 4A and 4B, two tables represent databases 300a, 300n stored at platforms 12a and 12n, respectively. Database 300a includes customer and deal information that is used by platform 12a and which is stored at data storage device 14a. Database 300n includes customer and deal information that is used by platform 12n and which is stored at data storage device 14n. As described above, platforms 12a and 12n operate different application software, each of which utilize and store different data,

As shown in FIGS. 4A and 4B, each of the tables include entries identifying particular real estate deals, customers, and contacts monitored by platforms 12a and 12n. The tables define a number of fields 302-312 for each entry for each database. These fields include: a deal identifier 302, a customer identifier 304, a contact identifier 306, deal details 308, customer details 310, and contact details 312. The information in database 300a may be created and updated, for example, based on information entered into platform 12a by an operator or from external data sources. The information in database 300n may be created and updated, for example, based on information entered into platform 12n by an operator or from external data sources. The data in database 300a is configured so that it is usable and accessible by application software run on platform 12a, while the data in database 300n is configured so that it is usable and accessible by application software run on platform 12n.

Similar databases (not shown) may be stored at other platforms 12 in system 10 (e.g., a platform 12c may have a database which stores data accessible by, and formatted for, application software run on platform 12c).

Deal identifier 302 may be any information used to identify a particular deal or transaction monitored by platforms of system 10. Deal identifier 302a (302n) is information used by platform 12a (platform 12n) to identify and track a particular deal. Customer identifier 304 may be information used to identify a particular customer or entity associated with the deal identified by deal identifier 302. Customer identifier 304a (304n) is information used by platform 12a (platform 12n) to identify and track a particular customer.

Contact identifier 306 may be information used to identify a particular individual or individuals at the customer identified by customer identifier 304. Contact identifier 306a (306n) is information used by platform 12a (platform 12n) to identify and track a particular point of contact.

Deal details 308 may be information used to describe the deal identified by deal identifier 302. The amount and nature of information included in deal details 308 depends on the needs of the platform with which it is used. For example, in the real estate example, deal details 308 may include information about the type of deal, information about the location of the property, information about the size of the deal, etc. Deal details 308a (308n) is information used by platform 12a (platform 12n) to identify and describe a particular deal identified by deal identifier 302a (302n).

Customer details 310 may be information used to describe the customer identified by customer identifier 304. Information included at 310 may include the name of the customer, a business address of the customer, and other contact information. Customer details 310a (310n) is information used by platform 12a (platform 12n) to provide contact and other information about the customer identified by customer identifier 304a (304n).

Contact details 312 may be information used to identify a particular point of contact at the customer identified at customer identifier 304. Information included at 312 may include the name of the point of contact, a business address of the contact, and other contact information. Contact details 312a (312n) is information used by platform 12a (platform 12n) to provide contact and other information about a particular point of contact at the customer identified by customer identifier 304a (304n).

As shown in databases 300a and 300b, a single customer may be referred to in a different manner by the two platforms. Further, each of the two platforms may store the data in a different format or using different indexing terms. Embodiments of the present invention permit the aggregation and maintenance of this data so that an entity operating the system has access to accurate and up-to-date information from each of the platforms.

This is achieved, in part, through the use of cross-reference and staging tables. Example cross-reference databases 400, 420 are shown in FIGS. 5A and 5B. Cross-reference databases 400, 420 may be stored at data storage device 32 or otherwise made accessible to aggregator 30. Each of the tables includes entries cross-referencing data from databases at platforms 12a and 12n. The tables define a number of fields 402-406 and 422-426 (respectively) for each database entry.

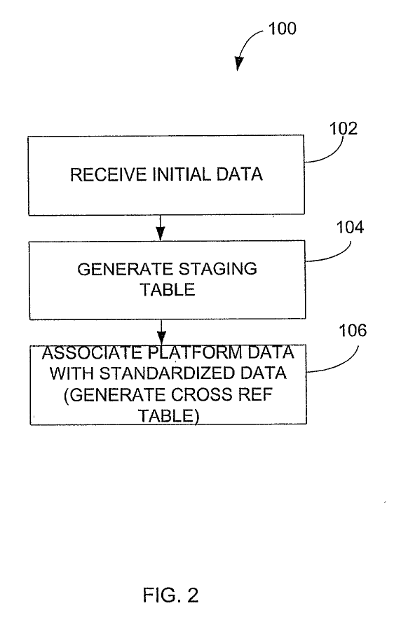

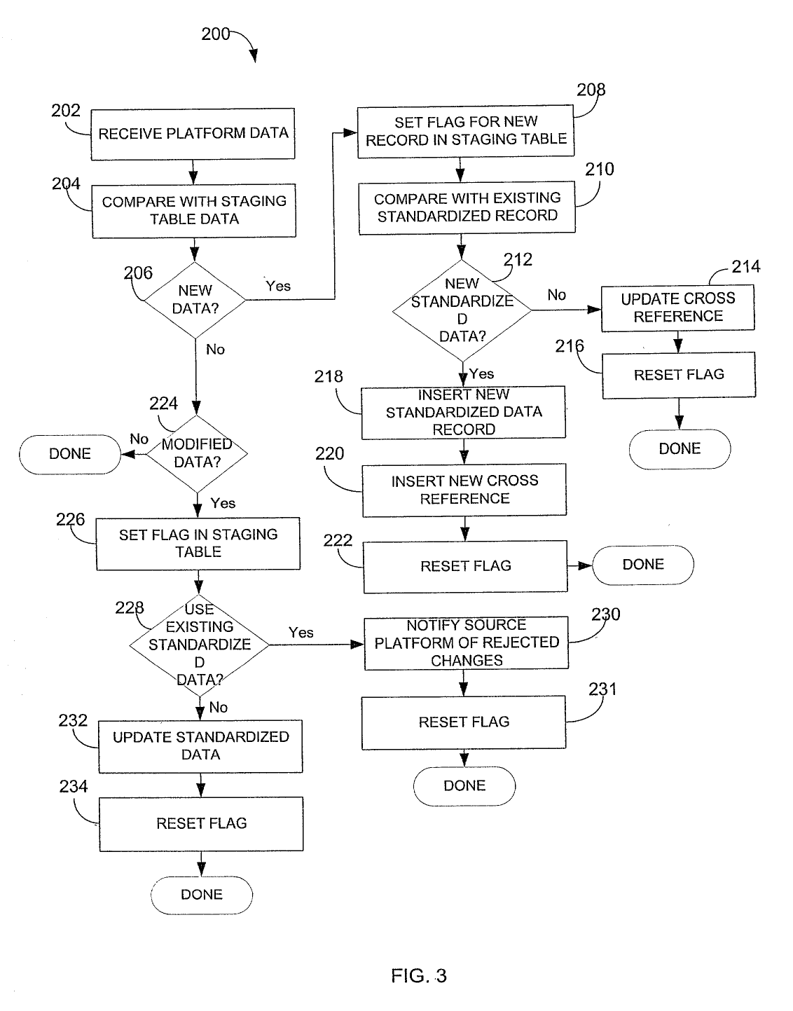

Database 400 includes fields specifying: a platform A deal identifer 402, a platform N deal identifier 404; and a standardized customer identifier 406. Database 420 includes fields specifying: a platform A customer identifier 422; a platform N customer identifier 424; and a standardized customer identifier 426. Further fields may be provided in each database if the system is required to aggregate and maintain data from more than two different platforms. The information in databases 400, 420 may be updated periodically as will be described further below in conjunction with a description of FIGS. 2-3.

According to one embodiment of the present invention, data from different platforms 12 is associated with a standardized set of data (item 50 of FIG. 1) through the use of cross-reference tables such as the tables depicted in FIGS. 5A and 5B. The standardized customer identifier 406 and 426 may be the same and may be automatically generated and assigned by aggregator 30. Through use of these cross-reference tables, and through use of staging tables (containing staging data 54 of FIG. 1) as will be described further below, embodiments of the present invention permit the aggregation and maintenance of multiple types and sources of data from different platforms.

Processing pursuant to embodiments of the present invention will now be described by first referring to FIG. 2, where a system initialization process 100 pursuant to one embodiment of the present invention is shown. In one embodiment, process 100 is performed under the control of software run by aggregator 30. Processing begins at 102 where initial data is received. This initial data is data generated by and stored at platforms 12a-n (e.g., such as the data shown in databases 300a, 300b described above). This data may be received by aggregator 30 via network 20 from each platform 12a-n. The data is preferably received in a format specified by an operator of aggregator 30, such as comma delimited text, or some other format.

Once the data is received, processing continues at 104 where a staging table is created (e.g., item 54 of FIG. 1). This staging table is generated and used to store the data received at 102 and to track changes, additions, and rejections of data as will be described further below in conjunction with FIG. 3.

Processing continues at 106 where platform data is associated with standardized data (e.g., item 50 of FIG. 1). In particular, processing at 106 results in the generation of one or more cross-reference tables (such as the tables shown and described above in conjunction with FIGS. 5A-5B). Cross-reference tables generated at 106 may be generated in any of a number of different forms. In one embodiment, each relevant data item that needs to be aggregated and maintained by aggregator 30 is included in the cross-reference tables. In the example depicted and described in conjunction with FIG. 5A and 6B above, the relevant data that is cross-referenced is the deal identifier, the customer identifier, and the contact identifier. Those skilled in the art will recognize that various combinations and types of data may be cross-referenced depending on the needs of the party operating the system. These cross-reference table(s) generated at 106 are used, as will be described, to maintain and update data from various platforms.

Referring now to FIG. 3, an exemplary data update process 200 is shown. In a currently-preferred embodiment, data update process 200 occurs after system initialization process 100 is performed to create one or more initial cross-reference tables. Data update process 200 may be performed on a periodic basis (e.g., hourly, daily, weekly, etc.) to ensure that data generated by each of the different platforms 12a-n is reflected in the standardized data 50 aggregated and maintained by aggregator 30. In other embodiments, data update process 200 is run only when necessary (e.g., only when data from platforms 12a-n is updated, added, or otherwise changed).

Data update process 200 begins at 202 where platform data is received from one or more platforms 12a-n of system 10. This data may be received via network 20 or by other means (e.g., by tape or diskette transfer, or the like). In one embodiment, the data is formatted in a format requested by aggregator 30 prior to the transfer. For example, the data may be formatted as comma-delimited text or some other format. A number of different data records may be received at the same time. If more than one record is received, process 200 is repeated for each record received.

At 204, the data received at 202 is compared with data in the staging table created at step 104 (as described in conjunction with FIG. 2, above). This comparison is performed for each record received. In the example introduced above, where customer information is generated and used by platforms 12a-n, processing at 204 may include determining if customer or deal information received from one of the platforms is new. For example, each record received at 202 may include a customer identifier (e.g., from field 304 of database 300 of FIG. 4). Processing at 204 may include searching the staging table to determine if the customer identifier received is already included in the staging table. If it is not already included in the staging table, the data is either new or modified.

A determination is made at 206 whether any new data (data not previously included in the staging table) is included in the received data. If new data is included in the received data, processing continues to 208 where a flag is set in the staging table indicating that a new record is to be added. A date associated with the flag may also be updated (to indicate that the flag was set to “NEW” on the present date).

Processing continues at 210 where the new record in the staging table (containing the new data identified at 206) is compared to existing records stored as standardized data at data storage device 32. A determination is made at 212 whether the new data included in the staging table includes data that is new (as compared to the previously stored standardized data 50). In one embodiment, processing at 212 is performed with the assistance of human review to ascertain whether the data should be added to the standardized data 50 as a new record.

In other embodiments, processing at 212 may be fully automated and the data may be added to the standardized data 50 as a new record if a determination is made at 212 that the data is new. Processing continues at 218 where a new record is inserted in the standardized data 50. The new record includes the new data received from the platform at 202. Processing continues at 220 where a new cross-reference to the new data is inserted into one or more cross-reference databases. A flag of the staging field is then reset to complete the process (for example, a flag may be set as “AU” to indicate that the new data has been “acted upon”). Processing at 204-212 and 218-222 help to ensure that only new data is entered as a new record in the standardized data database. As a result, users of the data can be sure that there is no duplication of information in the standardized data 50.

If processing at 212 indicates that there is no need to add new standardized data 50, processing continues at 214 where appropriate cross-reference databases are updated to reflect the existence of the new data received at 202. For example, a new record may be added to a cross-reference database correlating the new data from the platform with standardized data 50. Processing continues to 216 where a staging table flag is reset to complete the process. As an example, a flag of the staging table may be updated to indicate that the new data has been acted upon (e.g., the code “AU” may be used). Processing at 204-216 help to ensure that new data generated by one of the platforms 12 (but which does not require the creation of a new record in the standardized database) is properly cross-referenced to standardized data 50. Accordingly, users of the system can readily depend on the data from the various platforms 12 to be correlated to standardized data 50.

Returning to the determination at 206 of whether new data is present, processing continues at 224 if the determination indicates that the data is not new. A further determination is made at 224 whether the data is modified data. If the data is not modified, processing completes (e.g., the data from the platform(s) is consistent with the standardized data). If the data has been modified, processing continues at 226 where a flag in the staging table is set to indicate that data has been modified. The date and time of the update may also be referenced in the staging table for audit and control purposes.

Processing continues at 228 where a determination is made whether to use the existing standardized data 50 (e.g., to reject the data modification) or to accept the modified data received at 202. This determination may be made with human assistance or it may be performed automatically using a set of applied rules. If the determination indicates that standardized data 50 should be used, processing continues at 230 where the source platform is notified that the proposed changes have been rejected. The source platform may choose to modify the data to ensure that further data submissions are not rejected. Processing completes at 231 where a flag in staging table is set to indicate that the data has been rejected (e.g., the flag may be set to “R” to indicate the data has been rejected).

If processing at 228 indicates that standardized data will not be used, processing continues at 232 where the standardized data is updated to reflect the modified data received at 202. This may involve overwriting an entire record or a portion of a record. Processing continues at 234 where a flag in the staging table is reset to indicate that the data has been modified (e.g., a flag may be set to “AU” for “acted upon”).

Some or all of the steps of process 200 may be repeated as needed until all data from all platforms 12 in system 10 have been processed. At the end of this procedure, users of system 10 may comfortably rely on the consistency of the data aggregated and maintained by system 10.

Although the present invention has been described with respect to a preferred embodiment thereof, those skilled in the art will note that various substitutions may be made to those embodiments described herein without departing from the spirit and scope of the present invention.

What is claimed is:

1. A method of aggregating and maintaining data in a system having at least a first and a second platform generating data, comprising:
receiving initial data from said first and said second platforms;
generating a staging table based on said initial data; and
associating standardized data with said initial data.

2. The method of claim 1, wherein said associating includes generating a cross-reference table correlating said standardized data with initial data from said first platform and correlating said standardized data with said initial data from said second platform.

3. The method of claim 1, further comprising:
receiving updated data from said first and said second platforms.

4. The method of claim 3, further comprising:
comparing said updated data with data in said staging table.

5. The method of claim 4, further comprising:
determining if said updated data includes new data.

6. The method of claim 5, wherein said determining indicates that said updated data includes new data, the method further comprising:
setting a flag in said staging table;
comparing said updated data with said standardized data; and
determining if said standardized data should be updated to reflect said updated data.

7. The method of claim 6, wherein said determining indicates that said standardized data should be updated, the method further comprising:
inserting said updated data as a new record in said standardized data;
establishing a cross reference between said new record and said initial data.

8. The method of claim 7, further comprising:
resetting said flag.

9. The method of claim 6, wherein said determining indicates that said standardized data should not be updated, the method further comprising:
updating a cross-reference table correlating said standardized data with said updated data.

10. The method of claim 5, wherein said determining indicates that said updated data does not include new data, the method further comprising:
determining if said updated data includes modified data;
setting a flag in said staging table to indicate that said updated data includes modified data; and
determining whether said standardized data should be updated.

11. The method of claim 10, wherein said determining indicates that said standardized data should be updated, the method further comprising:
updating said standardized data; and
resetting said flag in said staging table.

12. The method of claim 10, wherein said determining indicates that said standardized data should not be updated, the method further comprising:
notifying said platform that said updated data has been rejected.

13. A system for aggregating and maintaining data, comprising:
a first platform having an application program generating first input data;
a second platform having an application program generating second input data; and
an aggregator comprising a processor, a comunications device in communication with said processor, adapted to receive said first and second input data, and a memory unit in communication with said processor and storing a program, wherein said processor is operative with said program to
compare said first input data with data in a staging table;
determine if said first input data are different from standardized data stored in said memory unit; and
add said first input data to said standardized data if a determination is made that said first input data are new.

14. The system of claim 13, wherein said processor is further operative with said program to:
update said standardized data if a determination is made that said first input data are modified.

15. The system of claim 13, wherein said processor is further operative with said program to:
compare said second input data with data in a staging table;
determine if said second input data are different from standardized data stored in said memory unit; and
add said second input data to said standardized data if a determination is made that said second input data are new.

16. The system of claim 15, wherein said processer is further operative with said program to:
update said standardized data if a determination is made that said first input data are modified.

17. An apparatus for aggregating and maintaining data across platforms, comprising:
means for receiving initial data from a first and a second platform;
means for generating a staging table based on said initial data; and
means for associating standardized data with said initial data.

18. A computer-readable medium having computer-executable instructions for performing steps, comprising:
receiving initial data from a first and a second platform;
generating a staging table based on said initial data; and
associating standardized data with said initial data.

19. A method for aggregating and maintaining data from a first and a second platform, comprising:
generating a staging table based on data from said first and said second platforms;
generating a set of standardized data;
generating a cross-reference table cross-referencing data from said first and said second platforms with said standardized data;
receiving updated data from said first and said second platforms;
identifying new data in said updated data;
updating said standardized data to include said new data; and
updating said cross-reference table to include said new data.

20. The method of claim 19, further comprising:
identifying modified data in said updated data; and
updating said standardized data to reflect said modified data.
